(19) United States
(12) Patent Application Publication
(10) Pub. No.: US 2023/0214530 A1
(43) Pub. Date: Jul. 6, 2023

(54) PERSISTENCE OF OBFUSCATED CONTENT IN LIVESTREAM DATA

(71) Applicant: International Business Machines Corporation, Armonk, NY (US)

(72) Inventors: Jacob Ryan Jepperson, St. Paul, MN (US); Zachary A. Silverstein, Georgetown, TX (US); Spencer Thomas Reynolds, Austin, TX (US); Jeremy R. Fox, Georgetown, TX (US)

(21) Appl. No.: 17/647,056

(22) Filed: Jan. 5, 2022

(51) Int. Cl. G06F 21/62; H04L 12/18

(52) U.S. Cl. CPC G06F 21/6263; H04L 12/1818; H04L 12/1822

(57) ABSTRACT

In an approach to persistence of obfuscated content in livestream data, one or more computer processors receive a video stream. One or more computer processors identify a physical writing space within the video stream. One or more computer processors capture text written on the physical writing space by a presenter. One or more computer processors store the captured text in a tracking corpus. One or more computer processors monitor a position of the presenter with respect to the physical writing space. One or more computer processors determine at least a subset of the captured text is obfuscated from a viewer of the video stream on a device of the viewer. One or more computer processors identify the at least subset of the captured text. One or more computer processors render the at least subset of the captured text in the device of the viewer.

### BACKGROUND OF THE INVENTION

The present invention relates generally to the field of livestream data rendering, and more particularly to persistence of obfuscated content in livestream data.

Web conferencing is used as an umbrella term for various types of online conferencing and collaborative services including webinars (“web seminars”), webcasts, and web meetings. Web conferencing applications offer data streams of text-based messages, voice, and video chat to be shared simultaneously across geographically dispersed locations. Applications for web conferencing include meetings, training events, lectures, or presentations from a web-connected computer to other web-connected computers. Depending on the technology being used, participants may speak and listen to audio over standard telephone lines or via computer microphones and speakers. Some products allow for use of a webcam to display participants, as well as screen sharing capability for display of content from a participant’s computer.

Optical character recognition (OCR) is the electronic or mechanical conversion of images of typed, handwritten, or printed text into machine-encoded text, whether from a scanned document, a photo of a document, a scene-photo (for example, the text on signs and billboards in a landscape photo), or from subtitle text superimposed on an image (for example, from a television broadcast). Widely used as a form of data entry from printed paper data records, OCR is a common method of digitizing printed texts so that they can be electronically edited, searched, stored more compactly, displayed online, and used in machine processes such as cognitive computing, machine translation, (extracted) text-to-speech, key data, and text mining. OCR is a field of research in pattern recognition, artificial intelligence, and computer vision.

### SUMMARY

Embodiments of the present invention disclose a computer-implemented method, a computer program product, and a system for persistence of obfuscated content in livestream data. The computer-implemented method may include one or more computer processors receiving a video stream. One or more computer processors identify a physical writing space within the video stream. One or more computer processors capture text written on the physical writing space by a presenter. One or more computer processors store the captured text in a tracking corpus. One or more computer processors monitor a position of the presenter with respect to the physical writing space. One or more computer processors determine at least a subset of the captured text is obfuscated from a viewer of the video stream on a device of the viewer. One or more computer processors identify the at least subset of the captured text. One or more computer processors render the at least subset of the captured text in the device of the viewer.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a content persistence program, on a server computer within the distributed data processing environment of FIG. 1, for persistence of obfuscated content in livestream data, in accordance with an embodiment of the present invention; and

FIG. 3 depicts a block diagram of components of the server computer executing the content persistence program within the distributed data processing environment of FIG. 1, in accordance with an embodiment of the present invention.

### DETAILED DESCRIPTION

Remote learning and educational content have been streamed through videos for many years. As technical barriers to video streaming are reduced, more users are participating in remote collaboration, for example, attendees of remote work meetings and early education teachers. Drawing on a computer screen with a mouse can be difficult for educators teaching a lesson as compared to writing on a physical writing space. In a live classroom, educators and/or presenters may be inclined to move around during a lesson or presentation. For remote learning, however, the presenter has to be aware of their location with respect to a chalkboard or whiteboard on which they have written content, so as not to block or obfuscate the previously written content. Embodiments of the present invention recognize that improvement to remote collaboration may be made by providing a system that captures written content using one or more optical character recognition (OCR) technologies and persists the data during video streams based on detected obfuscation, such that viewers can see the obfuscated text. Implementation of embodiments of the invention may take a variety of forms, and exemplary implementation details are discussed subsequently with reference to the Figures.

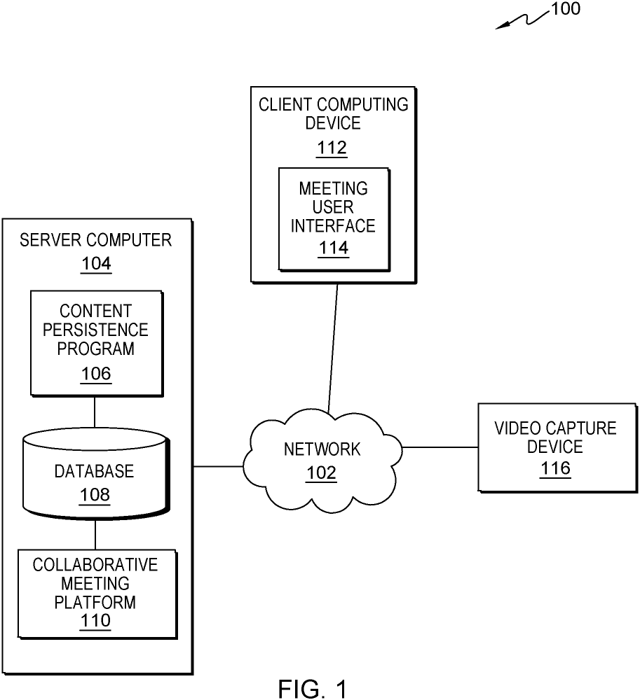

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, client computing device 112, and video capture device 116 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 112, video capture device 116, and other computing devices (not shown) within distributed data processing environment 100.

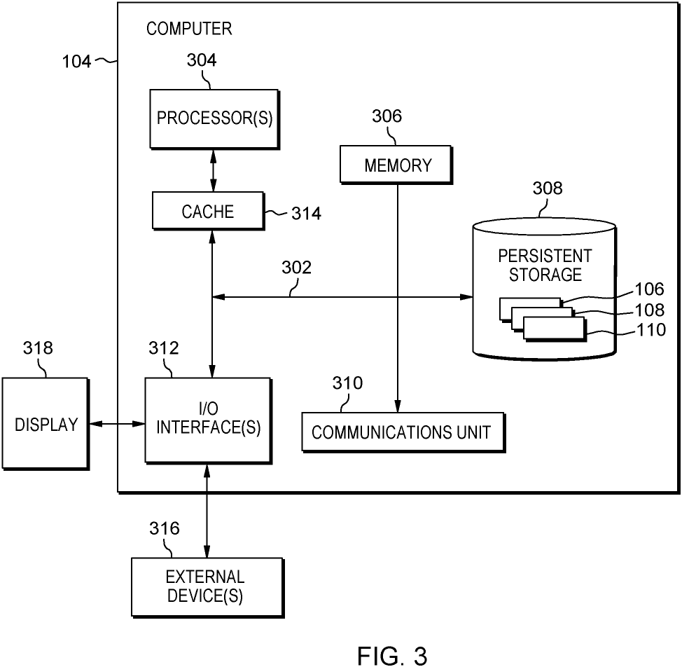

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 112 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes content persistence program 106, database 108, and collaborative meeting platform 110. Server computer 104 may include internal and external hardware components, as depicted and described in further detail with respect to FIG. 3.

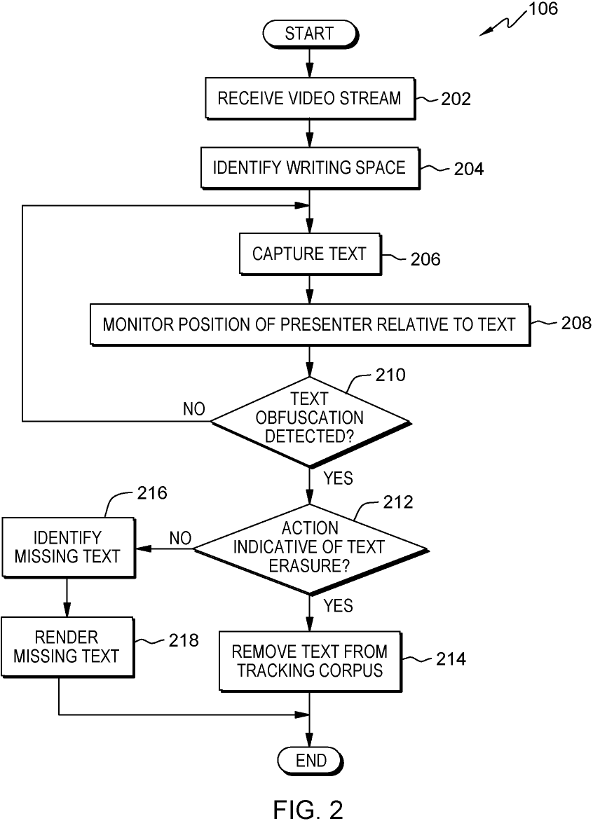

Content persistence program 106 captures handwritten text data on a physical medium, such as a whiteboard or chalkboard, that may be obfuscated by a presenter during a video stream and, if obfuscation is detected, persists the data using one or more visual methods to display the obfuscated text to a viewer. Content persistence program 106 receives a video stream. Content persistence program 106 identifies a writing space within the video stream. Content persistence program 106 captures text on the writing space and stores the text in a tracking corpus. Content persistence program 106 monitors a position of the presenter relative to the text. If content persistence program 106 determines text is obfuscated, then content persistence program 106 identifies the missing text. Content persistence program 106 renders the missing text. If content persistence program 106 determines an action of the presenter is indicative of erasure of text, then content persistence program 106 removes the erased text from the tracking corpus. Content persistence program 106 is depicted and described in further detail with respect to FIG. 2.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user’s information may be recorded or monitored and may be saved, for the purpose of reconstructing obfuscated content. These embodiments may also include periodic reminders of such recording and monitoring throughout the course of any such use. Certain embodiments may also include regular (e.g., daily, weekly, monthly) reminders to the participating parties that they have consented to being recorded and monitored for reconstructing obfuscated content and may provide the participating parties with the opportunity to opt-out of such recording and monitoring if desired. Furthermore, to the extent that any non-participating parties’ actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

Database 108 stores information used by and generated by content persistence program 106 and collaborative meeting platform 110. In the depicted embodiment, database 108 resides on server computer 104. In another embodiment, database 108 may reside elsewhere within distributed data processing environment 100, provided that content persistence program 106 and collaborative meeting platform 110 have access to database 108. A database is an organized collection of data. Database 108 can be implemented with any type of storage device capable of storing data and configuration files that can be accessed and utilized by content persistence program 106, such as a database server, a hard disk drive, or a flash memory. Database 108 stores a user profile for the user of client computing device 112. The user profile may include, but is not limited to, the name of the user, an address, an email address, a voice sample, a phone number, a credit card number, an account number, a student identification number, an employer, a job role, a job family, a business unit association, a job seniority, a job level, a resume, a social network affiliation, etc. The user profile may also include user preferences, such as defaults for collaborative meeting platform 110. User preferences may include preferences for content persistence program 106, for example, a preferred type of rendering (i.e., two-dimensional (2D), three-dimensional (3D), or augmented reality (AR)). In another example, the user may store a preference for content persistence program 106 act in response to a mouse click instead of rendering content automatically. Database 108 also stores text written on a writing space and captured by content persistence program 106 in a tracking corpus. In addition, database 108 stores an absolute or relative position of the text as it appears on the writing space.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Content persistence program 106 enables the authorized and secure processing of personal data. Content persistence program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Content persistence program 106 provides information regarding personal data and the nature (e.g., type, scope, purpose, duration, etc.) of the processing. Content persistence program 106 provides the user with copies of stored personal data. Content persistence program 106 allows the correction or completion of incorrect or incomplete personal data. Content persistence program 106 allows the immediate deletion of personal data.

Collaborative meeting platform 110 is one of a plurality of available software packages or online services with which users can hold live meetings, conferencing, presentations, and training via the Internet, particularly on TCP/IP connections. Collaborative meeting platform 110 may also be known as online meeting software or, sometimes, simply video conferencing. Collaborative meeting platform 110 enables remote meetings based on Voice over Internet Protocol (VoIP), online video, instant messaging, file sharing, and screen sharing. In the depicted embodiment, content persistence program 106 is a separate entity from collaborative meeting platform 110. In another embodiment, content persistence program 106 is an integrated component of collaborative meeting platform 110.

Client computing device 112 can be one or more of a laptop computer, a tablet computer, a smart phone, smart watch, a smart speaker, or any programmable electronic device capable of communicating with various components and devices within distributed data processing environment 100, via network 102. Client computing device 112 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch. In an embodiment, client computing device 112 may be integrated into a vehicle of the user. For example, client computing device 112 may include a heads-up display in the windshield of the vehicle. In general, client computing device 112 represents one or more programmable electronic devices or combination of programmable electronic devices capable of executing machine readable program instructions and communicating with other computing devices (not shown) within distributed data processing environment 100 via a network, such as network 102. Client computing device 112 includes an instance of meeting user interface 114.

Meeting user interface 114 provides an interface between content persistence program 106 and collaborative meeting platform 110 on server computer 104 and a user of client computing device 112. In one embodiment, meeting user interface 114 is mobile application software. Mobile application software, or an “app,” is a computer program designed to run on smart phones, tablet computers and other mobile devices. In one embodiment, meeting user interface 114 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. Meeting user interface 114 enables a user of client computing device 112 to participate in meetings held using collaborative meeting platform 110. Meeting user interface 114 enables a user of client computing device 112 to complete a user profile and store the profile in database 108. Content persistence program 106 interacts with and uses meeting user interface 114 to assist participants, such as the user of client computing device 112, in a collaborative meeting.

Video capture device 116 is one or more of a plurality of types of video camera, including, but not limited to, a digital single-lens reflex (DSLR) camera, a mirrorless camera, a point-and-shoot camera, a sports and action camera, a digital camcorder, a super chip camera, a webcam, a smartphone, etc. In an embodiment, video capture device 116 includes a motion detection component (not shown) that can monitor the movement of the presenter within the frame of the video stream.

FIG. 2 is a flowchart depicting operational steps of content persistence program 106, on server computer 104 within distributed data processing environment 100 of FIG. 1, for persistence of obfuscated content in livestream data, in accordance with an embodiment of the present invention.

Content persistence program 106 receives a video stream (step 202). In an embodiment, content persistence program 106 receives a video stream from video capture device 116. In an embodiment, the presenter may initiate the video stream by triggering video capture device 116 to begin streaming video.

Content persistence program 106 identifies a writing space within the video stream (step 204). In an embodiment, using one or more visual object extraction techniques, as would be recognized by a person of skill in the art, content persistence program 106 identifies an available and indexable writing space in the video stream. For example, content persistence program 106 identifies a whiteboard or a chalkboard in the video stream.

Content persistence program 106 captures text on the writing space (step 206). In an embodiment, content persistence program 106 uses an optical character recognition (OCR) engine (not shown) to extract text characters as the presenter writes on the writing space in the video stream. In an embodiment, content persistence program 106 generates a tracking corpus by storing the captured text in database 108. In an embodiment, content persistence program 106 stores the text with one or more indicators and/or one or more pointers based on relative and absolute coordinates of the text placement on the writing space. For example, an indicator may be a color highlight added to the captured text. In another example, a pointer may be a yellow arrow pointing at the text written on the board that is being referenced by the presenter. Relative positioning of the writing on the board being captured is needed for content persistence program 106 to accurately place the indicator and/or pointer when content persistence program 106 renders the text, as will be discussed with respect to step 218. In an embodiment, content persistence program 106 stores an image associated with the stored text. For example, content persistence program 106 may store an image of the content on the whiteboard. In an embodiment, content persistence program 106 stores a font associated with the stored text. For example, content persistence program 106 may choose a font that captures a visual aesthetic of the writing style.

Content persistence program 106 monitors a position of the presenter relative to the text (step 208). In an embodiment, content persistence program 106 continuously monitors the position of the presenter in the frame of the video stream with respect to the position of the text on the writing space. In an embodiment, content persistence program 106 monitors the position of any object in motion within the frame of the video stream. In an embodiment, content persistence program 106 uses a motion detection component within video capture device 116 (not shown) to monitor the position of the presenter and/or one or more moving objects in the video stream.

Content persistence program 106 determines whether text is obfuscated (decision block 210). In an embodiment, content persistence program 106 determines whether any subset of the text on the writing space is obfuscated, i.e., blocked, by the presenter or another object such that the blocked text cannot be viewed in the video stream. In an embodiment, content persistence program 106 determines whether the text is obfuscated for a period of time greater than a pre-defined threshold. For example, if the pre-defined threshold is ten seconds, then content persistence program 106 determines whether the text has been blocked for more than ten seconds.

If content persistence program 106 determines text is not obfuscated (“no” branch, decision block 210), then content persistence program 106 returns to step 206 to continue capturing text on the writing space.

If content persistence program 106 determines text is obfuscated (“yes” branch, decision block 210), then content persistence program 106 determines whether an action of the presenter is indicative of erasure of text (decision block 212). In an embodiment, content persistence program 106 determines whether an action of the presenter indicates the presenter erased at least a subset of the text in the writing space. For example, content persistence program 106 may detect the arm of the presenter moving back and forth across the writing space at a pre-defined rate. In another example, content persistence program 106 may detect the presenter grasping an eraser from the eraser tray below the writing space. In yet another example, content persistence program 106 may use a text-to-text comparison technique to detect a lack of text in the coordinates previously stored as including text.

If content persistence program 106 determines an action of the presenter is indicative of erasure of text (“yes” branch, decision block 212), then content persistence program 106 removes the erased text from the tracking corpus (step 214). In an embodiment, if content persistence program 106 detects that the presenter erased at least a subset of text on the writing space, then content persistence program 106 deletes the erased text from the tracking corpus in database 108. Since content persistence program 106 utilizes text present on the writing space, content persistence program 106 does not continue storing text that has been removed.

If content persistence program 106 determines an action of the presenter is not indicative of erasure of text (“no” branch, decision block 212), then content persistence program 106 identifies the missing text (step 216). In an embodiment, content persistence program 106 determines the absolute or relative position of the blocked text and retrieves the text associated with the determined position from the tracking corpus in database 108. In an embodiment, content persistence program 106 uses one or more text comparison algorithms, as would be recognized by a person of skill in the art, to identify the obfuscated text, i.e., the subset of text missing from the view of the video stream.

Content persistence program 106 renders the missing text (step 218). In an embodiment, content persistence program 106 uses one or more known techniques to render an image of the missing text as an overlay on the display screen of client computing device 112 as the user views the video stream such that the user of client computing device 112 can view the missing text even though the presenter, or some other object, is blocking the area of the writing space where the text is written. In an embodiment, content persistence program 106 renders the missing text in 2D on the screen as floating text. In another embodiment, content persistence program 106 renders the missing text in 3D on the screen. For example, content persistence program 106 may extract a PNG, i.e., a compressed raster graphic, as would be recognized by a person of skill in the art, or transparent type iteration of the image using artificial intelligence (AI) or other known techniques to eliminate whitespace in order to render the missing text. By using a transparent background instead of a white background, content persistence program 106 prevents items behind the rendering from becoming blocked. In another example, content persistence program 106 may automatically render the missing text in a flyout box above where the presenter is blocking. In an embodiment where client computing device 112 is a head mounted display in the form of a pair of glasses, content persistence program 106 renders the missing text in an AR space within the user’s field of view. In an embodiment, content persistence program 106 renders the missing text on the display of client computing device 112 in response to the user of client computing device 112 indicating a request to display missing text. For example, content persistence program 106 may render the missing text in response to the user moving a cursor to the location on the screen where the text is obfuscated.

In an embodiment, content persistence program 106 may render one or more stored indicators and/or pointers, such as content highlighting, based on what content is being presented and/or discussed, making it easier for a viewer to follow along. For example, if a presenter is discussing a specific piece of content, where the content is also written on the writing space, among many other items, then content persistence program 106 may provide a visual cue, such as overlaying a color highlight on the screen or placing a yellow arrow on the screen, to draw attention to the content being discussed.

In an embodiment, content persistence program 106 utilizes a subset of transparency on the presenter and/or another object blocking the written content. In the embodiment, content persistence program 106 may utilize a generative adversarial network (GAN) technique, as would be recognized by a person of skill in the art, based on previously captured images. For example, content persistence program 106 may mimic the appearance of transparency by lightening the presenter and overlaying the text, which the presenter is occluding, on top of the presenter in the displayed image.

In an embodiment, if content persistence program 106 determines the text is obfuscated for a period of time greater than a pre-defined threshold, then content persistence program 106 transmits a notification to the presenter. For example, content persistence program 106 may instruct video capture device 116 to emit a flash of light or a sound in order to notify the presenter that text has been blocked from the view of the video stream for an extended period of time.

In an embodiment, content persistence program 106 removes the rendered text overlay from the display on the screen of client computing device 112 after a pre-defined threshold period of time has elapsed. For example, content persistence program 106 may continue to render the missing text for thirty seconds. In an embodiment, content persistence program 106 discontinues the rendering of the missing text when the presenter moves to a position that does not obfuscate the text. In another embodiment, content persistence program 106 discontinues the rendering of the missing text in response to an indication from the user of client computing device 112 that the rendering is no longer needed. For example, content persistence program 106 may discontinue the rendering in response the user clicking on the rendered text with a mouse.

In an embodiment, content persistence program 106 includes the text capture technology to understand the handwritten content captures from the writing space. In the embodiment, if a user of client computing device 112 submits a question, via meeting user interface 114, to a chat associated with the presentation in collaborative meeting platform 110, then content persistence program 106 responds to the question in the chat space.

In an example of the use of content persistence program 106, a teacher uses collaborative meeting platform 110 to teach a class. The teacher walks in front of the whiteboard as students are trying to take notes and understand the text written on the whiteboard. When content persistence program 106 renders the missing text as an overlay on the video stream, the students are able to see all of the objects that the teacher has defined and written on the whiteboard. Further, the students are able to toggle the overlay on and off to ensure that they can see all the items when something comes into question regarding their viewpoint.

In another example of the use of content persistence program 106, a software developer hosts customer and partner workshops via collaborative meeting platform 110. While leading a workshop from their office, the software developer captures customer ideas on a whiteboard. The software developer continuously moves around the office, and, at times, blocks the key content and new material written on the whiteboard. Content persistence program 106 overlays a digital image of the content on the whiteboard blocked by the software developer such that the viewers can still see the content on their devices.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., content persistence program 106, database 108, and collaborative meeting platform 110, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 112 and video capture device 116. In these examples, communications unit 310 includes one or more network interface cards. Communications unit 310 may provide communications through the use of either or both physical and wireless communications links. Content persistence program 106, database 108, collaborative meeting platform 110, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., content persistence program 106, database 108, and collaborative meeting platform 110 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a video stream;
identifying, by one or more computer processors, a physical writing space within the video stream;
capturing, by one or more computer processors, text written on the physical writing space by a presenter;
storing, by one or more computer processors, the captured text in a tracking corpus;
monitoring, by one or more computer processors, a position of the presenter with respect to the physical writing space;
determining, by one or more computer processors, at least a subset of the captured text is obfuscated from a viewer of the video stream on a device of the viewer;
identifying, by one or more computer processors, the at least subset of the captured text; and
rendering, by one or more computer processors, the at least subset of the captured text in the device of the viewer.

2. The computer-implemented method of claim 1, further comprising:
determining, by one or more computer processors, an action indicative of erasure of the text from the physical writing space; and
deleting, by one or more computer processors, text associated with the action indicative of erasure from the tracking corpus.

3. The computer-implemented method of claim 2, wherein the action indicative of the erasure of the text from the physical writing space includes at least one of: an arm of the presenter moving back and forth across the physical writing space at a pre-defined rate, the presenter grasping an eraser from an eraser tray below the physical writing space, and using a text-to-text comparison technique to detect a lack of text in location coordinates associated with the captured text.

4. The computer-implemented method of claim 1, wherein rendering the at least subset of the captured text in the device of the viewer includes at least one of: rendering two-dimensional (2D) floating text on a screen associated with the device of the viewer, rendering three-dimensional (3D) text on the screen associated with the device of the viewer, rendering text in a flyout box, and rendering the captured text in an augmented reality space within a field of view of the viewer.

5. The computer-implemented method of claim 1, wherein determining the at least subset of the captured text is obfuscated from the viewer of the video stream on the device of the viewer further comprises:
determining, by one or more computer processors, the captured text is obfuscated for a first period of time greater than a first pre-defined threshold.

6. The computer-implemented method of claim 1, further comprising:
determining, by one or more computer processors, the at least subset of the captured text is obfuscated from the viewer of the video stream on the device of the viewer for a second period of time greater than a second pre-defined threshold; and
transmitting, by one or more computer processors, a notification to the presenter.

7. The computer-implemented method of claim 1, wherein storing the captured text in the tracking corpus further comprises:
storing, by one or more computer processors, one or more indicators and one or more pointers based on relative and absolute coordinates of a placement of the captured text on the physical writing space in association with the captured text.

8. The computer-implemented method of claim 1, further comprising:
receiving, by one or more computer processors, a request from the viewer to render the at least subset of the captured text in the device of the viewer.

9. A computer program product comprising:
one or more computer readable storage media and program instructions collectively stored on the one or more computer readable storage media, the stored program instructions comprising:
program instructions to receive a video stream;
program instructions to identify a physical writing space within the video stream;
program instructions to capture text written on the physical writing space by a presenter;
program instructions to store the captured text in a tracking corpus;
program instructions to monitor a position of the presenter with respect to the physical writing space;
program instructions to determine at least a subset of the captured text is obfuscated from a viewer of the video stream on a device of the viewer;
program instructions to identify the at least subset of the captured text; and
program instructions to render the at least subset of the captured text in the device of the viewer.

10. The computer program product of claim 9, the stored program instructions further comprising:
program instructions to determine an action indicative of erasure of the text from the physical writing space; and
program instructions to delete text associated with the action indicative of erasure from the tracking corpus.

11. The computer program product of claim 9, wherein the program instructions to render the at least subset of the captured text in the device of the viewer include at least one of: rendering two-dimensional (2D) floating text on a screen associated with the device of the viewer, rendering three-dimensional (3D) text on the screen associated with the device of the viewer, rendering text in a flyout box, and rendering the captured text in an augmented reality space within a field of view of the viewer.

12. The computer program product of claim 9, wherein the program instructions to determine the at least subset of the captured text is obfuscated from the viewer of the video stream on the device of the viewer comprise:
program instructions to determine the captured text is obfuscated for a first period of time greater than a first pre-defined threshold.

13. The computer program product of claim 9, the stored program instructions further comprising:
program instructions to determine the at least subset of the captured text is obfuscated from the viewer of the video stream on the device of the viewer for a second period of time greater than a second pre-defined threshold; and
program instructions to transmit a notification to the presenter.

14. The computer program product of claim 9, wherein the program instructions to store the captured text in the tracking corpus comprise:
program instructions to store one or more indicators and one or more pointers based on relative and absolute coordinates of a placement of the captured text on the physical writing space in association with the captured text.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a video stream;
program instructions to identify a physical writing space within the video stream;
program instructions to capture text written on the physical writing space by a presenter;
program instructions to store the captured text in a tracking corpus;
program instructions to monitor a position of the presenter with respect to the physical writing space;
program instructions to determine at least a subset of the captured text is obfuscated from a viewer of the video stream on a device of the viewer;
program instructions to identify the at least subset of the captured text; and
program instructions to render the at least subset of the captured text in the device of the viewer.

16. The computer system of claim 15, the stored program instructions further comprising:
program instructions to determine an action indicative of erasure of the text from the physical writing space; and
program instructions to delete text associated with the action indicative of erasure from the tracking corpus.

17. The computer system of claim 15, wherein the program instructions to render the at least subset of the captured text in the device of the viewer include at least one of: rendering two-dimensional (2D) floating text on a screen associated with the device of the viewer, rendering three-dimensional (3D) text on the screen associated with the device of the viewer, rendering text in a flyout box, and rendering the captured text in an augmented reality space within a field of view of the viewer.

18. The computer system of claim 15, wherein the program instructions to determine the at least subset of the captured text is obfuscated from the viewer of the video stream on the device of the viewer comprise:
program instructions to determine the captured text is obfuscated for a first period of time greater than a first pre-defined threshold.

19. The computer system of claim 15, the stored program instructions further comprising:
program instructions to determine the at least subset of the captured text is obfuscated from the viewer of the video stream on the device of the viewer for a second period of time greater than a second pre-defined threshold; and
program instructions to transmit a notification to the presenter.

20. The computer system of claim 15, wherein the program instructions to store the captured text in the tracking corpus comprise:
program instructions to store one or more indicators and one or more pointers based on relative and absolute coordinates of a placement of the captured text on the physical writing space in association with the captured text.
